(19) United States
(12) Patent Application Publication
(10) Pub. No.: US 2026/0120020 A1
(43) Pub. Date: Apr. 30, 2026

(54) SYSTEMS AND METHODS FOR MULTI-LEVEL PROCESS ORCHESTRATION AND STATUS MANAGEMENT

(71) Applicant: ServiceNow, Inc., Santa Clara, CA (US)

(72) Inventor: Sagar Gupta, Bangalore (IN)

(21) Appl. No.: 18/933,445

(22) Filed: Oct. 31, 2024

(51) Int. Cl. G06Q 10/0631; G06Q 10/0633

(52) U.S. Cl. CPC G06Q 10/06316; G06Q 10/0633

(57) ABSTRACT

A method includes receiving a request to generate a process orchestration and a log associated with the process orchestration, wherein the log includes data associated with one or more objects and associated processes, identifying the one or more objects and associated processes from the log, identifying correlations among the one or more objects and associated processes, generating the process orchestration based on the one or more objects, associated processes, and their correlations, wherein the process orchestration includes one or more process hierarchies including workflows for the one or more objects, and one or more process groups linked to the one or more process hierarchies.

### TECHNICAL FIELD

The present disclosure relates generally to multi-level process orchestration and status management, particularly for enterprise operations.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

An enterprise may utilize cloud computing resources to perform processes defined by one or more workflows that provide products and/or services, collectively referred to as objects. Sometimes, a process associated with an object (e.g., a vehicle) may involve one or more other objects (e.g., a third-party purchase order), which may be referred to as sub-objects for the process. A workflow may be used to monitor the status of the object. However, it may be difficult to monitor the statuses of sub-objects using the workflow of the object. Sometimes, the enterprise may utilize various resources (e.g., Enterprise Resource Planning (ERP), Customer Relationship Management (CRM), etc.) associated with a given object, and multiple logs may be generated for the given object by different resources. These logs may include information associated with the processes of the given object and may be used to create a chain of processes. For example, the logs may include identifications (IDs) (e.g., a correlation ID, a transaction ID) for tracking the processes. However, it may be difficult to track the statuses of the given object since the logs may be used for multiple process executions, and the given object may have undergone multiple state transitions due to the execution of multiple processes. For example, in some processes, the given object may be the primary object of the processes, while in other processes, the given object may be the sub-object. Accordingly, new techniques for tracking processes associated with a given object are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving a request to generate a process orchestration and a log associated with the process orchestration, wherein the log includes data associated with one or more objects and associated processes, identifying the one or more objects and associated processes from the log, identifying correlations among the one or more objects and associated processes, generating the process orchestration based on the one or more objects, associated processes, and their correlations, wherein the process orchestration includes one or more process hierarchies including workflows for the one or more objects, and one or more process groups linked to the one or more process hierarchies.

In another embodiment, a system includes processing circuitry and a memory, accessible by the processing circuitry, storing instructions that, when executed by the processing circuitry, cause the processing circuitry to execute a client instance. The client instance is configured to receive a request to generate a process orchestration and a log associated with the process orchestration, wherein the log includes data associated with one or more objects and associated processes, identify the one or more objects and associated processes from the log, identify correlations among the one or more objects and associated processes, and generate the process orchestration based on the one or more objects, associated processes, and their correlations, wherein the process orchestration includes one or more process hierarchies including workflows for the one or more objects, and one or more process groups linked to the one or more process hierarchies.

In a further embodiment, a non-transitory, computer readable medium stores instructions that, when executed by processing circuitry, cause the processing circuitry to receive a request to generate a process orchestration and a log associated with the process orchestration, wherein the log includes data associated with one or more objects and associated processes, identify the one or more objects and associated processes from the log, identify correlations among the one or more objects and associated processes, and generate the process orchestration based on the one or more objects, associated processes, and their correlations, wherein the process orchestration includes one or more process hierarchies including workflows for the one or more objects, and one or more process groups linked to the one or more process hierarchies.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server, which supports and enables a client instance, and hosts a process orchestration tool, in accordance with aspects of the present disclosure;

FIG. 5 is a schematic of an embodiment of an object used by the process orchestration tool of FIG. 4, and having a sub-object and a process group, in accordance with aspects of the present disclosure;

FIG. 6 is a schematic of an embodiment of a process orchestration, implemented via the process orchestration tool of FIG. 4, with multiple objects, associated scenario groups, process hierarchies, and process subgroups, in accordance with aspects of the present disclosure;

FIG. 7 is a schematic of an embodiment of a status management framework that may be implemented in the process orchestration of FIG. 6, in accordance with aspects of the present disclosure;

FIG. 8 is a framework of a model that may be used to extract entities of a process orchestration from a log for the process orchestration tool of FIG. 4, in accordance with aspects of the present disclosure; and

FIG. 9 is a flowchart of a process for process orchestration generation, according to an embodiment of the disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As discussed herein, an enterprise may perform processes defined by one or more workflows to provide products and/or services, collectively referred to as objects. However, it may be difficult to monitor the statuses of sub-objects using only the workflow of the object. For example, an enterprise may use one resource to track procurement of an object and another to track transactions of an object, wherein tracking is accomplished by observing generated logs containing multiple records or fields. As such, it is difficult to link all related processes together, given an object may have several records indicating state changes due to the execution of multiple processes. Accordingly, new techniques for tracking processes associated with a given object are needed.

Implementations described herein are directed to systems and methods to monitor and track processes associated with objects by using a multi-level process orchestration, which may be used for status management including managing the statuses of the objects and any sub-objects that might be involved in these processes. Objects and the associated processes may be identified from logs (e.g., by doing a semantic search) and linked into hierarchies and scenarios, which may be used to generate a multi-level process orchestration that supports status management both at object level and hierarchy level.

Various embodiments herein are direct to executing a multi-level process orchestration by a model. The logs may include context information for the objects and the associated business, such as applications of the objects, scenario ID, business ID, business type, publisher ID, reference ID, hierarchy ID, process ID, etc. Word vectors may be generated (e.g., by using word embedding models) for the context information in the logs. The word vectors may be used to identify the objects, the associated processes, and the correlations among them from the context information. The multi-level process orchestration may be generated based on the identified objects, the associated processes, and the correlations among them. The multi-level process orchestration may include scenarios, which may include processes to be performed for corresponding objects. A scenario may include one or more process hierarchies having hierarchical levels linked to process groups. A process hierarchy may include a sub-workflow associated with processes for one or more entities (e.g., an object, a sub-object, etc.). A process group may include a corresponding logical grouping of processes related to an action (e.g., procurement) to be performed for an entity (e.g., an object, a sub-object, etc.). A hierarchy level status for a hierarchy level of a process hierarchy may be determined based on a set of conditions completed in the hierarchy level, and a hierarchy status for the process hierarchy may be determined based on the hierarchy level statuses of all the hierarchy levels in the process hierarchy. A status of an entity (e.g., an object, a sub-object, etc.) at any step (e.g., any hierarchy level, any process) of the workflow in the multi-level process orchestration may be determined based on related hierarchy level statuses of the hierarchy levels associated with the entity. Accordingly, statuses of all entities in the multi-level process orchestration at any step of the workflow may be monitored and tracked. In addition, the multi-level process orchestration may also support status management both at both the object level and hierarchy level. For example, a status (e.g., a hierarchy level status, an object status) may be assigned and updated based on predetermined conditions.

Use of the disclosed techniques may enable an enterprise to use the process orchestration generated by the methods disclosed herein to identify workflows, manage workflow statuses, and execute workflows. Accordingly, using the disclosed techniques, tracking and execution methods for complex processes may be improved.

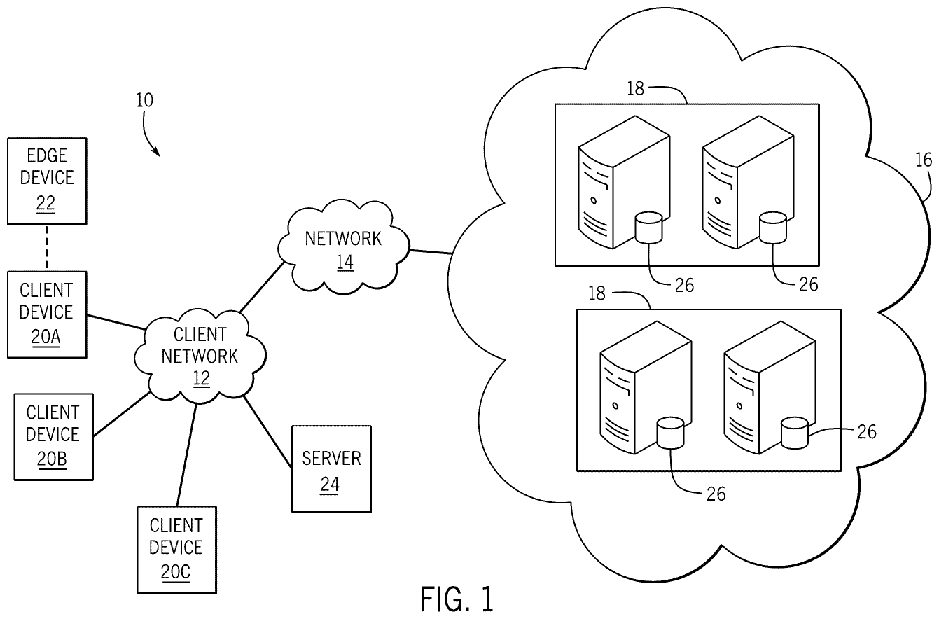

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

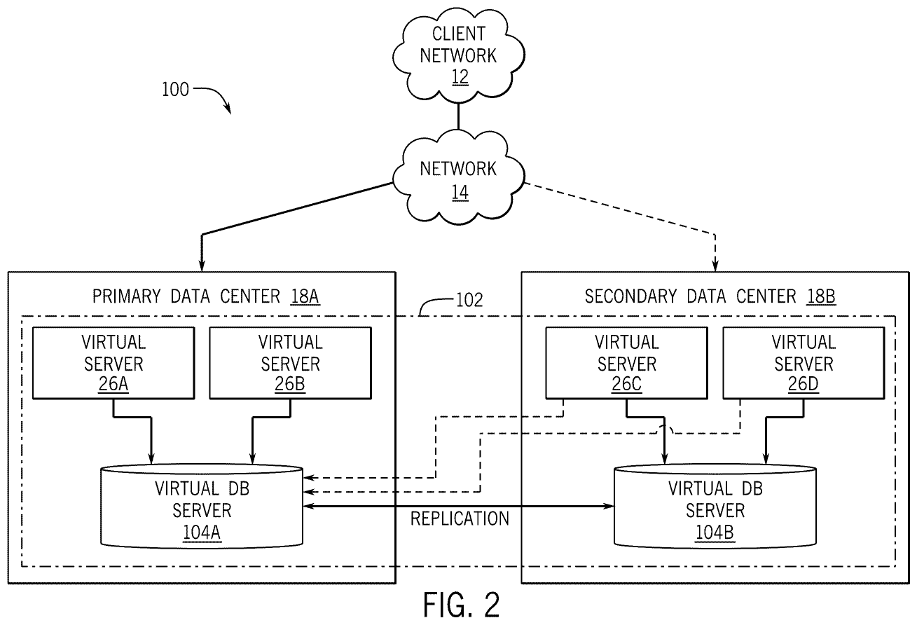

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

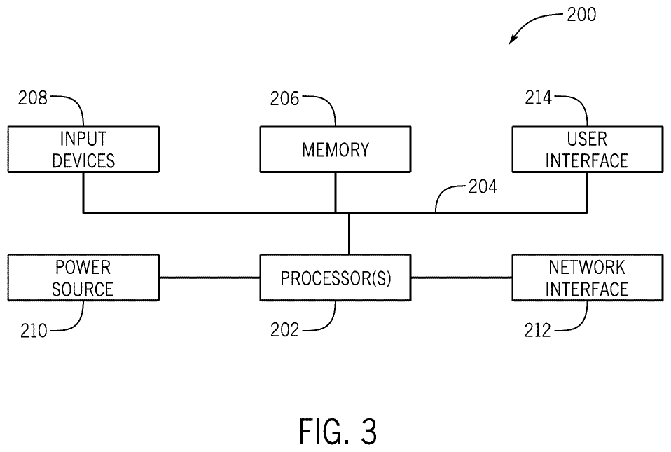

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

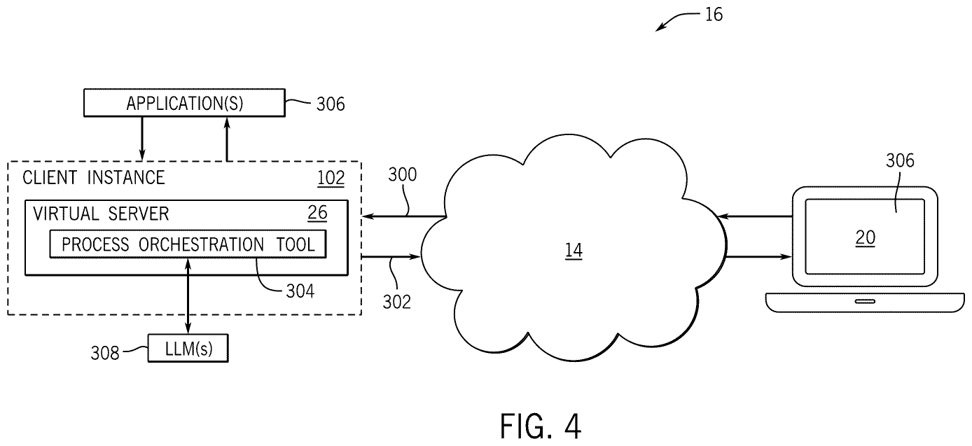

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via an application or web browser running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using a web browser and/or an application. For example, the client device 20 may transmit inputs 300 (e.g., requests) and the client instance 102 generate and transmit outputs 302 (e.g., responses). The client instance 102 hosts a process orchestration tool 304. In certain embodiments, the client instance 102 may interface with one or more applications 306 (e.g., applications running on the client device 20, applications running on the virtual server 26, internal applications or external, third-party applications running on resources external to the virtual server 26 and the client device 20), such as an Enterprise Resource Planning (ERP) or Customer Relationship Management (CRM) application related to organizing, initiating, and executing processes. Though application 306 is shown as separate from the client instance 102, network 14, and client device 20 for the purpose of illustration, it should be clear from the examples listed that, in practice, all or part of the application 306 may execute on the client instance 102 or virtual server(s) 26, on a client device 20, and/or on a third-party platform communicated with via the network 14.

Upon initiating a process orchestration request, the process orchestration tool 304 may generate and transmit a user interface to receive definitions of logical objects of a multi-level process hierarchy. For example, a user interface transmitted by the process orchestration tool 304 may prompt a user of the client device(s) 20 to provide various information about the process orchestration, such as desired objects, sub-objects, scenarios, process groups, and process hierarchies. Additionally, the inputs may identify pre-conditions for the process orchestration such as object dependencies and cardinality. As such, the process orchestration tool 304 may use the inputs received to generate the process orchestration.

Furthermore, the process orchestration tool 304 may receive a log via the application 306. For example, to develop a process orchestration for a warehouse product, the application 306 may be an ERP application having a log including multiple records describing transactions and processes of warehouse materials. Upon submitting the request, the process orchestration tool 304 may transmit a prompt via the client device(s) 20 to grant the process orchestration tool 304 access to the log via the application 306. Alternatively, in certain embodiments, the process orchestration tool 304 may be capable of receiving the log as a file format (e.g., CSV files, JSON files, XML files, etc.)

To implement the process orchestration tool 304, logic may be stored in scripts in a scripts database (which may the same or different from the virtual database servers 104A, 104B shown in FIG. 2) on the server 26 side, either stored on or accessible by the virtual server 26 and/or the client instance 102. Specifically, as is described in more detail below, when a request to generate a process orchestration is received, the client instance 102 identifies the script(s) that defines the process orchestration and retrieves the script(s) from the scripts database. The client instance 102 uses logs obtained from the application 306 and executes the retrieved script(s). Execution of the script results in data being generated, which is transmitted to the client device 20 as outputs 302. The client device 20 may provide additional requests 300 for additional process orchestrations, which may cause the client instance 102 to run or re-run the retrieved scripts, resulting in additional data, which may be transmitted back to the client device 20 as an additional output 302.

In certain embodiments, the process orchestration tool 304 may perform checks to validate requests via the retrieved script(s). For example, the process orchestration tool 304 may determine if the type of application 306 and the process orchestration requested are compatible. As such, the client instance 102 may run or re-run the retrieved scripts, resulting in additional data, which may be transmitted back to the client device 20 as an additional output 302.

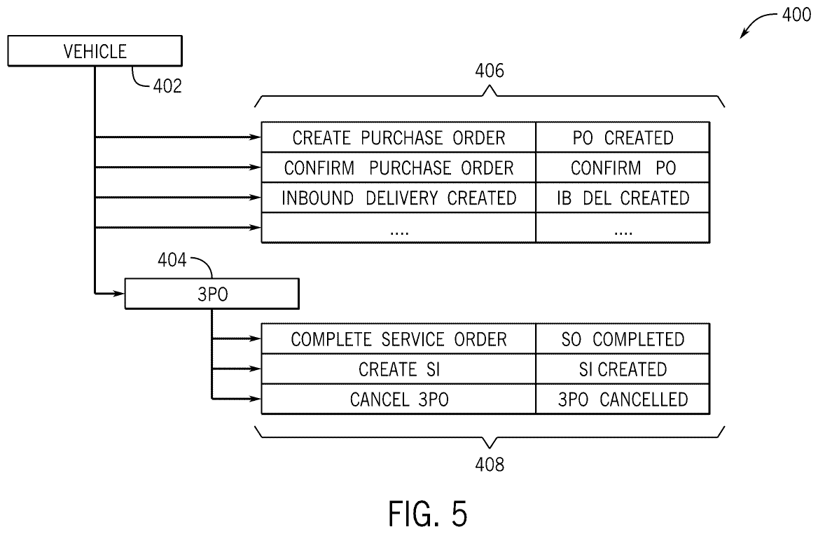

FIG. 5 is an example of a framework 400 of an object 402 linked to a process group 406 and a sub-object 404 having its own process group 408. As previously discussed, an object 402 is an entity on which a scenario is executed and may be related to a service, product, process, a combination thereof, or the like. Moreover, an object 402 may have one or more statuses indicating the progression of its associated workflow(s). For example, for a service object relating to procurement, an object may have a status of “PO created” when initiated and “PO confirmed” when complete. Further, an object may be related to outside applications not related to resources available by the application of FIG. 3. For example, an object may be managed by an ERP application and acted upon by a Warehouse Management System (WMS) of the ERP application.

An object 402 may be linked to a process group 406 or a sub-object 404 having its own process group 408. In the illustrated example, the object 402 relating to a vehicle is linked to a process group 406. The process group 406 may include any number of processes grouped together by likeness and related directly to the object 402. In the illustrated embodiment, the object 402 is linked to the process group 406 relating to procurement via a purchase order. Accordingly, the process group 406 includes processes such as creating a purchase order, confirming a purchase order, and creating an inbound delivery, etc. Further, the processes of the process group 406 may also be linked to statuses indicating the creation, execution, completion, etc. of each process. For example, upon completing a process related to creating a purchase order, a linked status may be altered to indicate the process is complete. In other cases, where the process may not yet be complete, the linked status may indicate that the process is open or incomplete. Accordingly, the overall status of the object 402 may depend on the individual statuses of the process group 406 and the status of the sub-object 404.

In the illustrated example, the object 402 is linked to a sub-object 404. The sub-object 404 may be any service, product, or process associated with the object 402, having its own independent lifecycle. For example, as indicated in the illustrated embodiment, a business may need to create a third-party purchase order to complete a service (e.g., maintenance, quality inspection, etc.) on the object 402 (e.g., vehicle). As such, in the framework 400, a third-party purchase order may be created as a sub-object 404. The sub-object 404 may be linked to other sub-objects, or process groups. In the illustrated embodiment, the sub-object 404 is linked to a process group 408 including the processes to carry out a third-party purchase order and the linked statuses of the respective processes. Moreover, an advantage presented by the use of sub-objects 404 is the capability of determining a position within the lifecycle of the sub-object based on the completion status of the processes within the process group 408.

By the framework 400, a suitable workflow for an object 402 may be determined. For example, the vehicle object 402 of the illustrated embodiment may have a workflow including accomplishing the processes of the process group 406 by achieving a “complete” status for the third-party purchase order sub-object 404. Although an example of a framework 400 having one object 402, a linked process group 406, and a sub-object 404, is illustrated, it should be understood that a business may include multiple objects linked to multiple process groups and sub-objects over any number of levels. For example, a manufacturing company may include a framework 400 for a manufactured product (object), having an extensive bill of materials (sub-objects), with service requirements on the manufactured product and materials of the bill of materials (process groups). Accordingly, it should be understood that sub-objects 404 and process groups 406 and 408 may correlate to complex workflows having multiple hierarchy levels.

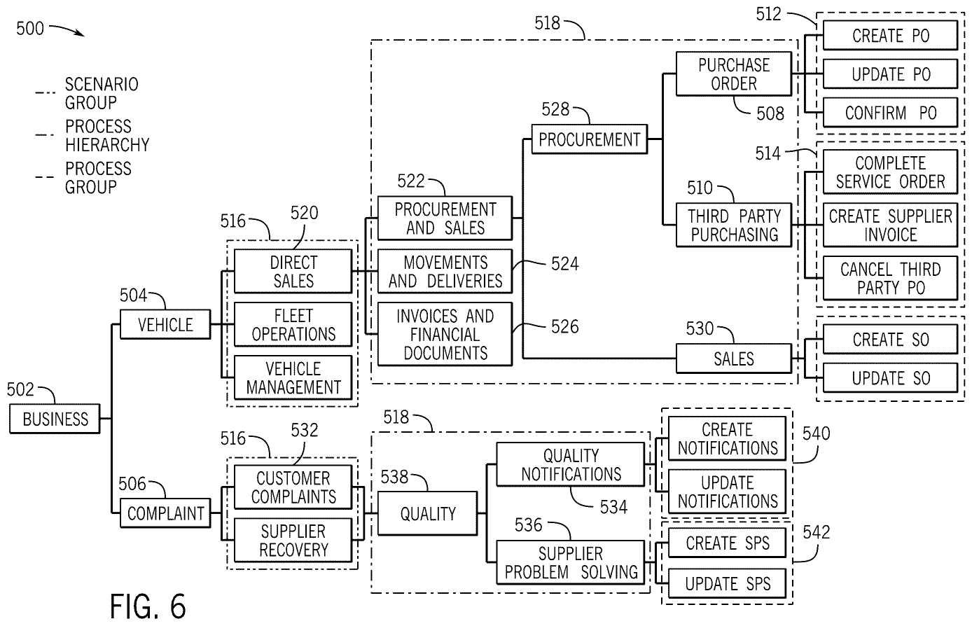

With the foregoing in mind, FIG. 6 is an example of a multi-level process orchestration 500 for a business 502 having a vehicle object 504 and a complaint object 506, each having respective workflows. A multi-level process orchestration 500 may define a suitable data structure for managing entities and relationships between entities. Accordingly, the status of an object, sub-object, process-group, and/or process may be determined based on its relationships to other entities. Moreover, the multi-level process orchestration 500 may provide a method of executing certain actions within an application, based on the hierarchy set forth by the multi-level process orchestration.

In the illustrated embodiment, the business 502 has a hierarchy spanning up to six levels with varying directionality. As such, when using the multi-level process orchestration 500, statuses may be generated for any valid object of the hierarchy by traversing its dependent objects. For example, if a user of the multi-level process orchestration 500 wished to know the status of procurement with respect to the vehicle object 504, statuses may be returned indicating the status of the purchasing order object 508 and third-party purchasing object 510 determined by each respective process group 512, 514. Furthermore, the object status may be updated based on predetermined conditions of the process orchestration. In certain embodiments, an object may not update to a “complete” status until all dependent processes are completed. In some embodiments, an object may not update to a “complete” status until its dependent sub-object(s) is updated to a “complete” status. Although two embodiments of predetermined conditions are discussed herein, it should be noted that a wide number of predetermined conditions may be applied to determine an object status.

The levels of the process orchestration 500 may be grouped together by the type of objects contained within the group including scenario groups 516, process hierarchies 518, and process groups 512, 514. A scenario group 516 may include a group of objects representing groups of business scenarios for an object, thereby facilitating the associated process hierarchies 518. For example, in the illustrated embodiment, a vehicle object 504 has a linked scenario group 516 containing objects describing business operations related to vehicles such as direct sales 520, fleet operations, and vehicle management. Each object of the scenario group 516 may thereby facilitate respective process hierarchies 518 and record a status based on the process hierarchy and any applicable predetermined conditions. In certain embodiments, a process orchestration 500 may wait until a predetermined condition is met to generate a scenario group 516. For example, a predetermined condition may include ensuring that each object of the scenario group 516 depends from an object 504, 506.

A process hierarchy 518 may include steps to complete scenarios represented by the objects of the scenario group 516, thereby defining a workflow. Accordingly, a process hierarchy 518 may have multiple objects, sub-objects and process groups to define the steps and sequences of processes. For example, in the illustrated embodiment, the scenario direct sales 520 may have multiple process streams affecting its status, including procurement and sales 522, movement and deliveries 524, and invoices and financial documentation 526. As such, each process stream, having multi-step processes, may be represented by an object having sub-objects and process groups representing steps to provide a status for the process stream object. In the illustrated embodiment, a procurement and sales object 522 may have a status dependent on the process status of sub-object procurement 528 and sub-object sales 530. Accordingly, the status of the aforementioned object may reflect a combined status of the sub-objects such as “PO created” and “SO created”. In addition to providing the status of process stream objects, a process hierarchy 518 may have predetermined conditions that may be used to manage the execution of such processes. For example, a predetermined condition may be set that a purchase order must be created upon the creation of a purchase order object.

Furthermore, the process orchestration 500 may provide a method of monitoring the status of process hierarchies 518. A process hierarchy status may be determined by statuses of the component hierarchy levels. For example, a user may wish to know the status of the process hierarchy 518 relating to customer complaints 532. As such, the process orchestration 500 may provide a status of the hierarchy levels, where the first hierarchy level includes the quality notification 534 and supplier problem solving 536 objects, and the second hierarchy level includes the quality object 538. By providing each hierarchy level status, a hierarchy status may be determined. For example, if both hierarchy levels include objects displaying a “complete” status thereby indicating the hierarchy level status as “complete”, the process orchestration 500 may indicate that the hierarchy status for customer complaints 532 is “complete”. It should be understood, however, that the status of a hierarchy and hierarchy level may be dependent on other factors, such as the set of predetermined conditions entered by a user of the process orchestration.

Process groups 512, 514, 540, and 542 may include the individual steps necessary to satisfy the conditions of the object from which it depends. For example, in order to complete a purchase order 508, the process subgroup 512 may contain a list of steps such as creating the purchase order, updating the purchase order, and confirming the purchase order. Upon completing all steps of the process group 512 (e.g., each status is marked as complete), the object the process group 512 depends from, purchase order 508, may be marked as complete. In some embodiments, the status of the object the process group 512 depends from may reflect the status of all steps listed within the process group 512.

In addition to indicating the status of objects, hierarchies, and hierarchy levels, the multi-level process orchestration 500 may provide a method of executing processes defined by hierarchies based on relationships having varying cardinalities. Accordingly, any relationship between an entity may have a cardinality parameter indicating the type of relationship between the two entities. For example, an object may be linked to a process group, wherein the link contains a cardinality parameter describing the number of times processes of the process group may be executed. In certain embodiments, at a hierarchy level, a cardinality parameter may define the number of times a sub-hierarchy process may be executed, thereby encompassing a number of entities (e.g., objects, sub-objects, process groups.)

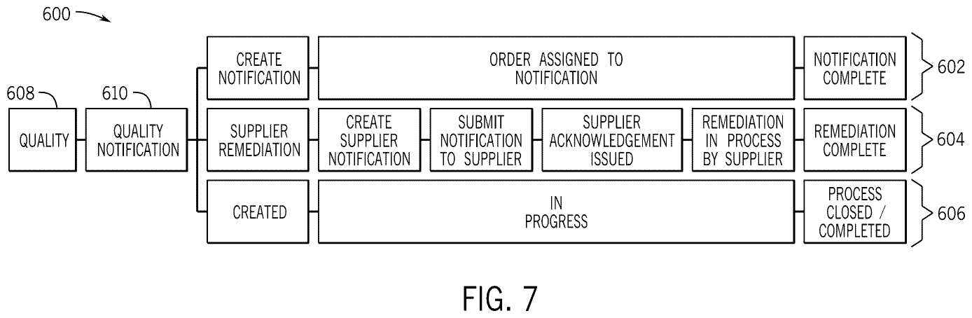

FIG. 7 is an example of a status management framework 600 that may be implemented to provide the statuses of objects of the process orchestration. As previously discussed, upon execution of the process orchestration request, a number of objects and process groups may be identified. In addition, a set of conditions may be defined in order to determine the status of an object. Accordingly, the status management framework 600 may allow such conditions to be determined by indicating the specific lifecycle of a process. As such, the status management framework 600 may be applied to an object or a hierarchy, thereby defining the logic to be implemented within a process orchestration in order to assign statuses.

The illustrated embodiment of FIG. 7 is directed towards a status management framework 600 for managing a quality object 608. The sub-object may represent a particular process to be completed under the object 608, such as a quality notification sub-object 610. As previously described, due to a condition of completing a process with an independent lifecycle, such as supplier remediation, to complete an internal business process, such as the quality notification, it may be difficult to determine the overall status of the quality notification sub-object 610 without a link to the supplier remediation. As such, in order to determine the steps to complete a quality notification sub-object 610, the status management framework 600 may create and compare its depending groups, such as a stream process group 606, a condition process group 604, and a status group 602.

The stream process group 606 may provide the overall process for completing the process of the sub-object 610. For example, in the illustrated embodiment, the stream process group 606 represents the steps to complete a quality notification, wherein the notification task must be created, completed by a third-party (e.g., “in progress”), and closed.

The condition process group 604 may provide the actual processes defining conditions required to progress through the stream process group 606. Accordingly, it should be understood that a status management framework 600 may have multiple condition process groups 604. In the illustrated embodiment, a supplier remediation occurs prior to consideration of the quality notification as complete. As such, the status management framework 600 may align processes described in the condition process group 604 with corresponding processes of the stream process group 606. For example, the quality notification may not be considered “in progress” until the supplier notification has been created.

The status group 602 may provide the statuses of the sub-object 610 based on the stream process group 606 and the condition process group 604. For example, if processes are complete up until the supplier notification creation step within the condition process group 604, the stream process group 606 may indicate “in progress” thereby allowing the sub-business object status to update to “Order Assigned to Notification.”

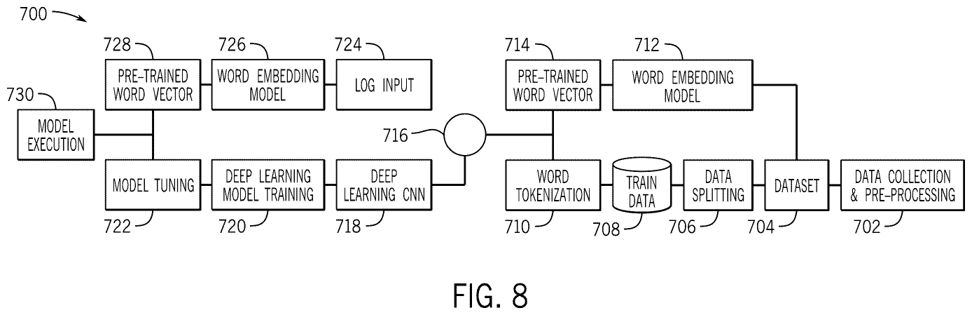

FIG. 8 illustrates a process 700 that may be used to extract information from a log automatically. As previously discussed, a log may provide information detailing transactions relating to entities, thereby defining the workflow of a process execution. However, it may be difficult to extract the workflow of the process execution due to multiple process executions on an entity. As such, the model produced by the process 700 provides a method to identify objects and processes from a log. Furthermore, by performing a semantic search using the model, correlations between entities may be determined, allowing a process orchestration generation step to be performed.

As previously described, a log may contain multiple records or fields containing information related to processes. In certain embodiments, individual records or fields of the log may have unique identifiers indicating one or more characteristics of the record. For example, an individual record of a log may contain a process ID, a hierarchy ID, and a correlation ID, indicating the process type, hierarchy level, and cardinality of the individual record respectively. As such, the individual record may be identified as an object having a certain logical location within a process hierarchy based on its unique identifiers. While one example of a log record having three unique identifiers is discussed above, it should be understood that a record may contain any number of unique identifiers. Furthermore, the unique identifiers may be any identifier assigned by the application, such as a scenario ID, business ID, publisher ID, reference ID, hierarchy ID, process ID, etc. As such, the process 700 may be used to identify from the log types of processes, objects, and correlations by such unique identifiers.

At block 702, data collection and pre-processing may be initiated. The data collected at this block may be a log comprising multiple log records containing identifiers and text generated by an application during operations. In addition to data collection, the process 700 may require that the data is processed by methods such as cleaning, filtering, and transforming the data in a suitable manner for further operations.

After collecting data at block 702, at block 704 a dataset may be generated. Generating the dataset may include grouping the data together and organizing the data in a manner suitable for further operations. Upon the creation of the dataset at block 704, the process 700 may proceed to use and manipulate the dataset. As such, the process 700 moves to block 706 and 712. The operations applied before the junction 716 (e.g., blocks 706-710 and 712-714) may be completed simultaneously or independently.

Moving to block 712, the process 700 may include using a word embedding model to generate word vectors from the dataset. The word embedding model may be any application capable of learning word embeddings and text classifications. As such, the dataset generated at block 704, containing suitable data representations of the log generated by the application, may be converted to a number of pre-trained word vectors representative of the contents of the log at block 714.

At block 706, the process 700 may include performing data splitting on the dataset of block 704. For example, the dataset may be split into sub-datasets for the purpose of evaluating the data, testing the data, or training the model. Accordingly, at block 708, the process 700 may include generating training data. The training data may be a suitable set of data, determined by the block 706, that may be labeled and used for training a machine learning model. By using the training data determined at block 708, the process 700 may implement word tokenization at block 710. In this manner, a word tokenization process may include segmenting text of the training data into units (e.g. word tokens) for the purpose of further processing, as discussed in detail below. As such, at block 710, a number of word tokens may be produced based on the training data.

As previously mentioned, the junction 716 represents synthetization of the methods described by blocks 704-710 and blocks 712-714. Accordingly, the junction 716 may produce a deep learning convolution neural network (CNN) at block 718 based on the pre-trained word vectors of block 714 and the word tokenization of block 710. As such, the CNN model may be trained at block 720. Upon the completion of sufficient training, the CNN model may be tuned by any parameters at block 722. For example, after observing the training behavior of the model at block 720, an option for an operator to adjust one or more parameters of the model may be presented.

Blocks 724-728 represent the input of a log for use by the model developed by block 722. At block 724, the process 700 may include receiving a log from an application. At block 726, the process 700 may use a word embedding model, as previously mentioned, to learn text classifications and word embeddings. Accordingly, pre-trained word vectors may be developed at block 728. Upon converting the input log into pre-trained word vectors, the pre-trained word vectors may be used as input into the tuned model of block 722.

As such, the model may execute at block 730. The process 700 may allow the automatic extraction of information regarding objects and processes from the log, thereby allowing the multi-level process orchestration generation. As previously mentioned, the process 700 may allow for name-entity semantic searches to be conducted, facilitating the identification of objects and associated sub-objects and processes. Accordingly, a multi-level process orchestration may be generated similar to that of the process orchestration of FIG. 7.

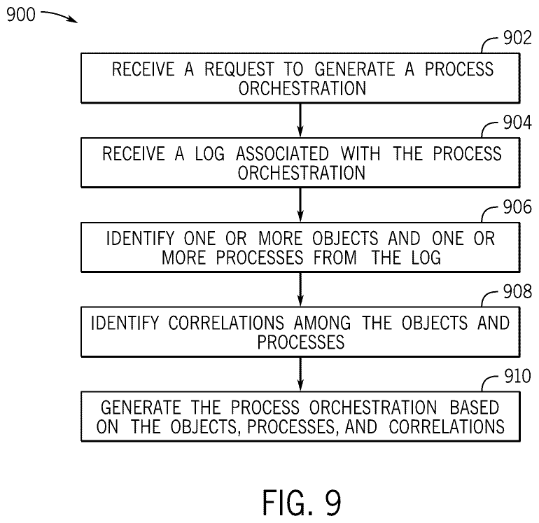

FIG. 9 is a flowchart of a process 900 for generating a process orchestration. At block 902, the process 900 receives a request to generate a process orchestration. The request may be received from a client device via an application (e.g., an ERP application, CRM application, etc.) or browser. In certain embodiments, the request may contain information relating to a certain product or service utilizing process orchestration. For example, the process 900 may receive a request to generate a process orchestration for a vehicle at block 902. While the previous example discloses requesting a process orchestration for a single object, it should be understood that a process orchestration may be generated having any number of objects with any number of dependent entities. The request, which may be received as an input to the process 900, may be received as natural language (e.g., spoken or written free text, as opposed to processor-executable code or defined options or choices), the first few characters of an option presented, spoken language, a gesture, selection of a button or a drop-down menu, a keystroke, selection via mouse or stylus, a combination thereof, or any other type of input.

At block 904, the process 900 receives a log associated with the process orchestration. As previously mentioned, the log may contain details relating to correlations between products, actions, and services, recorded by the application. As such, any log associated with the request received at block 902 may be used to generate the process orchestration.

At block 906, the process 900 identifies one or more objects and one or more processes from the log received at block 904. As such, block 906 may execute the model of FIG. 8. Upon executing the model of FIG. 8, a number of objects and processes may be extracted from the log indicating the process orchestration may occur for such objects and processes. Accordingly, the automatic identification of objects by use of the model of FIG. 8 may increase the efficiency of generating a process orchestration by providing an alternative to manual object identification, thereby reducing resource expenditure.

At block 908, the process 900 identifies correlations among the objects and processes. In certain embodiments, the process of FIG. 8 may be executed and used to perform a name-entity semantic search to identify correlations between objects and processes. As such, the process of identifying correlations may be automated, thereby reducing resource expenditure. Furthermore, identifying correlations by use of the model of FIG. 8 may reduce the complexity of generating a process orchestration for an enterprise having multiple applications. For example, an object identified from the log may exist logically within a WMS application and a CRM application. Accordingly, by automatically identifying correlations related to the object, cross-referencing between the two applications may be streamlined.

At block 910, the process 900 may generate the process orchestration based on the objects and processes and associated correlations. Upon generating the process orchestration, a multi-level process orchestration similar to that of FIG. 6 may be provided. The generated process orchestration may be transmitted to the requesting device, application, browser, etc. Furthermore, the process orchestration may be integrated into an application. For example, the process orchestration may be used for status monitoring of a specific object within the multi-level process orchestration.

In certain embodiments, the process 900 may include receiving an additional log from a different application, associated with an already generated process orchestration. As such, the process 900 may be executed and configured to incorporate objects, sub-objects, and processes, into the already generated process orchestration. Accordingly, the process 900 may be configured to receive multiple logs at varying stages of process orchestration generation.

The presently disclosed techniques are directed to systems and methods to monitor and track processes associated with objects by using a multi-level process orchestration, which may be used for status management including managing the statuses of the objects and any sub-objects that might be involved in these processes. Objects and the associated processes may be identified from logs (e.g., by doing a semantic search) and linked into hierarchies and scenarios, which may be used to generate a multi-level process orchestration that supports status management both at object level and hierarchy level. By use of the process orchestration generated by the methods disclosed herein, an enterprise may identify workflows, manage workflow statuses, and execute workflows. Furthermore, the use of automation may reduce the need for manual labor to accomplish the aforementioned tasks, thereby increasing the efficiency of the process and reducing associated labor costs.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a request to generate a process orchestration;
receiving a log associated with the process orchestration, wherein the log comprises data associated with one or more objects and one or more processes associated with the one or more objects;
identifying the one or more objects and the one or more processes from the log;
identifying correlations among the one or more objects and the one or more processes; and
generating the process orchestration based on the one or more objects, the one or more processes, and the correlations, wherein the process orchestration comprises:
one or more process hierarchies comprising workflows for the one or more objects; and
one or more process groups linked to the one or more process hierarchies, wherein each of the one or more process groups comprises at least one process of the one or more processes associated with at least one object of the one or more objects.

2. The method of claim 1, comprising:
generating respective hierarchy level statuses for hierarchy levels of a process hierarchy of the one or more process hierarchies based on respective sets of conditions completed in the hierarchy levels.

3. The method of claim 2, comprising:
generating a hierarchy status for the process hierarchy based on the respective hierarchy level statuses.

4. The method of claim 2, comprising:
generating an object status for an object of the one or more objects based on the respective hierarchy level statuses.

5. The method of claim 4, comprising:
updating the object status based on one or more predetermined conditions completed in the process orchestration.

6. The method of claim 5, wherein the one or more predetermined conditions comprise a completion of a process of the one or more process.

7. The method of claim 4, wherein the object status comprises a status of a sub-object.

8. The method of claim 1, wherein a hierarchy level of a process hierarchy of the one or more process hierarchies is assigned a cardinality parameter defining respective counts for a set of processes executed in the hierarchy level.

9. The method of claim 1, comprising:
receiving an additional log associated with the process orchestration, wherein the additional log comprises additional data associated with the one or more objects and the one or more processes; and
identifying the one or more objects and the one or more processes from the additional log, wherein the log and the additional log were created by different logging programs.

10. The method of claim 1, comprising:
generating a plurality of word vectors for the data; and
identifying the one or more objects and the one or more of processes from the log using the plurality of word vectors.

11. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving a request to generate a process orchestration;
receiving a log associated with the process orchestration, wherein the log comprises data associated with one or more objects and one or more processes associated with the one or more objects;
identifying the one or more objects and the one or more processes from the log;
identifying correlations among the one or more objects and the one or more processes; and
generating the process orchestration based on the one or more objects, the one or more processes, and the correlations, wherein the process orchestration comprises:
one or more process hierarchies comprising workflows for the one or more objects; and
one or more process groups linked to the one or more process hierarchies, wherein each of the one or more process groups comprises at least one process of the one or more processes associated with at least one object of the one or more objects.

12. The system of claim 11, wherein the operations comprise:
generating respective hierarchy level statuses for hierarchy levels of a process hierarchy of the one or more process hierarchies based on respective sets of conditions completed in the hierarchy levels.

13. The system of claim 12, wherein the operations comprise:
generating a hierarchy status for the process hierarchy based on the respective hierarchy level statuses.

14. The system of claim 12, wherein the operations comprise:
generating an object status for an object of the one or more objects based on the respective hierarchy level statuses.

15. The system of claim 14, wherein the operations comprise:
updating the object status based on one or more predetermined conditions completed in the process orchestration.

16. A non-transitory, computer readable medium comprising instructions that, when executed by processing circuitry, cause the processing circuitry to perform operations comprising:
receiving a request to generate a process orchestration;
receiving a log associated with the process orchestration, wherein the log comprises data associated with one or more objects and one or more processes associated with the one or more objects;
identifying the one or more objects and the one or more processes from the log;
identifying correlations among the one or more objects and the one or more processes; and
generating the process orchestration based on the one or more objects, the one or more processes, and the correlations, wherein the process orchestration comprises:
one or more process hierarchies comprising workflows for the one or more objects; and
one or more process groups linked to the one or more process hierarchies, wherein each of the one or more process groups comprises at least one process of the one or more processes associated with at least one object of the one or more objects.

17. The non-transitory computer readable medium of claim 16, wherein a hierarchy level of a process hierarchy of the one or more process hierarchies is assigned a cardinality parameter defining respective counts for a set of processes executed in the hierarchy level.

18. The non-transitory computer readable medium of claim 16, wherein the operations comprise:
generating respective hierarchy level statuses for hierarchy levels of a process hierarchy of the one or more process hierarchies based on respective sets of conditions completed in the hierarchy levels.

19. The non-transitory computer readable medium of claim 18, wherein the operations comprise:
generating a hierarchy status for the process hierarchy based on the respective hierarchy level statuses.

20. The non-transitory computer readable medium of claim 18, wherein the operations comprise:
generating an object status for an object of the one or more objects based on the respective hierarchy level statuses.
